(19) United States
(12) Patent Application Publication
(10) Pub. No.: US 2017/0258654 A1
(43) Pub. Date: Sep. 14, 2017

(54) NOVEL BED SYSTEM ATTACHABLE TO A HOSPITAL BED

(71) Applicant: GDV TECHNOLOGY APS, Greve (DK)

(72) Inventors: Jens GOTH, Koebenhavn OE (DK); Viorel CHICINAS, Viborg (DK)

(21) Appl. No.: 15/532,028

(22) PCT Filed: Nov. 30, 2015
(86) PCT No.: PCT/DK2015/050366

§ 371 Date: May 31, 2017

(30) Foreign Application Priority Data
Dec. 3, 2014 (DK) PA 2014 70760

(51) Int. Cl. A61G 7/00; A61G 7/057; A61G 7/002

(52) U.S. Cl. CPC A61G 7/001; A61G 7/002; A61G 7/057

(57) ABSTRACT

There is provided a bed system that is simple to install on existing hospital beds and which does not require any modification of the existing bed. The bed system has a first and a second frame nested in a common pivot means, and actuators connected thereto in order to establish an angle formed between the frames, where they are rotatable about a longitudinal axis through activation of the actuators. The system is mounted on a base frame, which can be attached to an existing frame of a hospital bed.

### FIELD OF THE INVENTION

The present invention relates to adjustable beds. More specifically this invention relates to beds where the frame and mattress are divided in a longitudinal fashion to move parts of the bed in order to bed sores.

### BACKGROUND OF THE INVENTION

Elderly and disabled people who spend long periods of time in bed are susceptible to bedsores. These people must be turned frequently in order to reduce the likelihood of bedsores. At present, health and safety regulations stipulate that three people must be used to turn the occupant of the bed. This is not efficient. In addition, large strains are placed on the back of the people turning the person over.

In addition, elderly, disabled people and people with motor control problems are at risk of falling out of bed, whether asleep or awake. This is a further problem in that the person may not be able to get back into the bed or even to raise an alarm. Barriers can be placed on the sides of the beds but these barriers may cause injury to the person or one of their limbs by striking the barriers.

A great number of disabled people find it impossible to either adjust their sleeping position or to arise from a prone position, i. e. at night when having retired to bed, without the help of another person which can be costly and inconvenient. In addition, the disabled person experiences a lack of independence.

It is of extreme importance that a disabled person has to be turned or to have their position adjusted at regular intervals to maintain good circulation, ease cramps and avoid bedsores, which can occur by remaining in one position for long periods.

Wheelchair users find it difficult to straighten their legs easily in bed. Frequently, disabled people or their helpers will place a pillow below their knees in order to raise their knees and to maintain the legs in a more comfortable slightly bent position. However, the pillow becomes more compact and the support provided reduces and, also, the pillow does not provide support across the full width of the bed. Furthermore, the pillow position may move and stable support is not provided.

U.S. Pat. No. 2,113,286 discloses a hospital bed where the frame and mattress are divided longitudinally and each section pivots 90 degrees from the horizontal. The hospital bed has guardrails and the pivotal movement is accomplished in a manual fashion. The bed is secured in an angular position through the use of support members resting in notches.

U.S. Pat. No. 3,230,554 discloses a motion regulator device to control the relative movement of objects. This device uses a motorized power screw to regulate relative motion in mechanical systems. The device relates specifically to the application of such devices to adjustable beds, chairs or sofas to regulate relative movement between various sections thereof.

U.S. Pat. No. 4,658,451 discloses a carrier for supporting a person in different postural positions. It contains a hydraulic drive means for pivoting the main rest area to allow the patient to be turned over, supported on their side or transferred.

EP1486191A1 discloses an adjustable bed system for turning a patient. The bed system includes a tilt mechanism adapted to tilt the platform surface laterally, a side member disposed on a side of the platform, a side-member lift mechanism adapted to raise the side member relative to the platform surface, and the tilt mechanism tilting the platform surface toward the side member raised by the side-member lift mechanism. Meanwhile, it does not include sliding means horizontally movable perpendicular to the central longitudinal axis of a hospital bed, when the bed system is attached to said hospital bed.

None of the above disclosures, taken either singly or in combination, is seen to describe the instant invention as claimed. There is a need for a simple bed system that can move specific body parts in order to avoid bed sores. Such a bed system should be easy to attach to existing hospital beds.

### SUMMARY OF THE INVENTION

The present invention solves the problems associated with the prior art by providing a system that is simple to install on existing hospital beds and which does not require any modification of the existing bed. Moreover, in one embodiment of the present invention specific body parts, such as lower and upper extremeties, can be moved independently.

According to a first aspect of the present invention there is provided a bed system (1) attachable to a hospital bed for turning a patient in order to avoid pressure sores, said bed system (1) comprising:
a first (2) and a second (3) frame each having a top (4) and bottom (5) frame member, said first (2) and a second (3) frame attached in first (20) and second (30) sliding means at the central longitudinal axis of the hospital bed onto which the system (1) is attachable, whereby the sliding means is horizontally movable perpendicular to the central longitudinal axis of the hospital bed;
a first (6) and a second (7) actuator connected to said first (2) and second (3) frame via one or more extension rods (8) attached via a lifting device (9) to pivot points (10) provided as joints (11) on the bottom (5) frame member;
said first (2) and second (3) frames being pivotally movable around an axis parallel with the length of the bed through the joints (11) provided on the bottom (6) frame member; and
a base frame (12) having attachment means (13) for attachment of the bed system to an existing frame of a hospital bed;
   wherein activation of the first (6) and second (7) actuator moves the pivot points (10) horizontally, whereby said first (2) and second (3) frames are nested to form a sloped support descending towards the longitudinal center line of the bed system.

In a preferred embodiment of the present invention the extension rods (8) interact with a scissor lifting device, which by actuation lifts the frame in the pivot point.

Further it is preferred that the attachment means on the base frame is adapted to be attached on the longitudinal or transversal bars of a hospital bed, said attachment means has a recess for receiving the longitudinal or transversal bars and fastening means for securing it thereto.

In a particularly preferred embodiment the first and/or second actuator is based on an electrical actuator attached to the one or more extension rods, preferably to the first rod.

The control means is preferably programmed to move the first and a second frame up and down, while ensuring a minimum angle therein between of at least 40 degrees.

In a preferred embodiment of the present invention there is provided transversally extending and slidably support members secured on the top frame members so that the support members can slide in the longitudinal axis of the first and/or second frame. This is particularly suitable for patients that need additional support in the heel regions.

In a second aspect the present invention provides an integrated hospital bed comprising a hospital bed, and at least two bed systems of the present invention. In this way different body parts can be moved independently.

In a third aspect the present invention provides an integrated hospital bed comprising a hospital bed, and at least two bed systems of the present invention, wherein longitudinal connection bars are provided to interconnect the one or more extension rods so as to establish parallel movement of the frame parts in the entire length of the bed. In this embodiment the entire bed is moved because of the connection bars.

### BRIEF DESCRIPTION OF THE DRAWINGS

FIG. 1 is a sectional view of a lifting part of the bed system.

FIG. 2 is a sectional view of the scissor lifting device, which by actuation lifts the frame in the pivot point.

FIG. 3 shows how the frame is attached in a joint to ensure correct nesting when lifted by the lifting device.

### DETAILED DESCRIPTION OF THE INVENTION

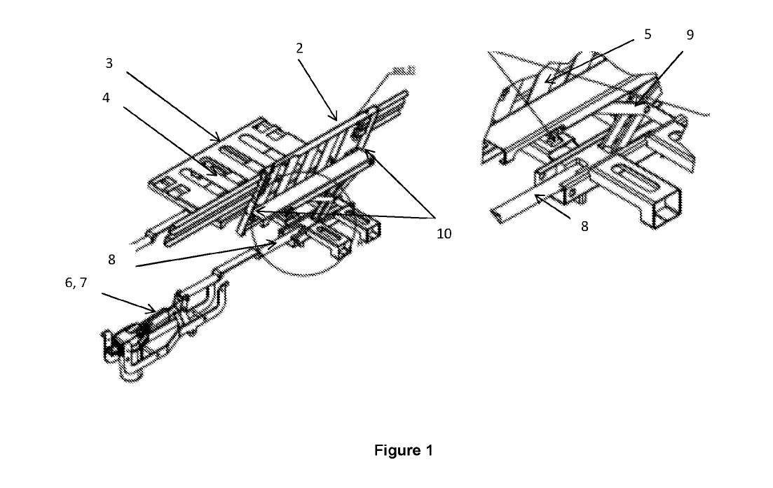

Referring to FIG. 1 there is shown the lifting part of the bed system (1) that is ready to be attached to a hospital bed for turning a patient in order to avoid pressure sores. The figure shows scissor lifting device, which by actuation lifts the frame in the pivot point. An actuator is connected to the frame via one or more extension rods activating the scissor lifting device. Control means (not shown) are provided for moving the frame.

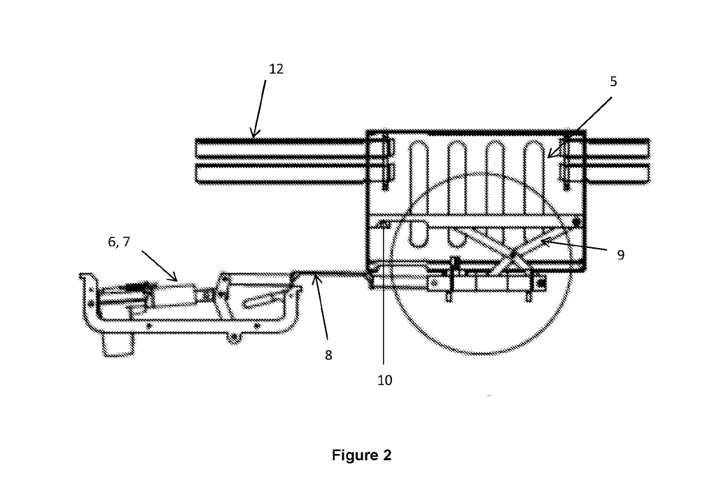

FIG. 2 shows the embodiment of FIG. 1 in more detail to further illustrate the mechanism of the scissor lifting device.

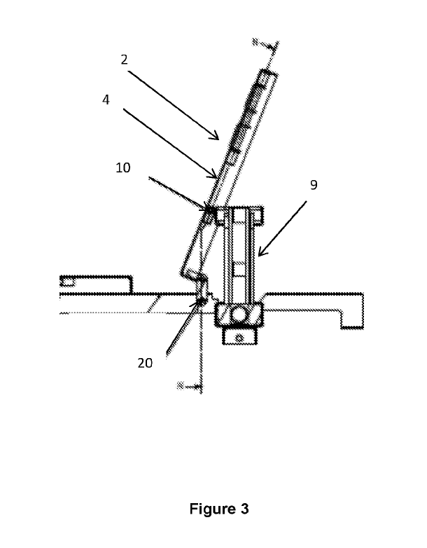

In FIG. 3 there is shown how the first (2) frame is attached in the first (20) sliding means at the central longitudinal axis of the hospital bed onto which the system is attached. When the first (2) frame is nested by the scissor lifting device then the first (20) sliding means moves horizontally towards the central longitudinal axis of the hospital bed.

1. A bed system attachable to a hospital bed for turning a patient in order to avoid pressure sores, said bed system comprising:
a first and a second frame each having a top and bottom frame member, said first and a second frame attached in first and second sliding means at the central longitudinal axis of the hospital bed onto which the system is attachable, whereby the sliding means is horizontally movable perpendicular to the central longitudinal axis of the hospital bed;
a first and a second actuator connected to said first and second frame via one or more extension rods attached via a lifting device to pivot points provided as joints on the bottom frame member;
said first and second frames being pivotally movable around an axis parallel with the length of the bed through the joints provided on the bottom frame member; and
a base frame having attachment means for attachment of the bed system to an existing frame of a hospital bed;
wherein activation of the first and second actuator moves the pivot points horizontally, whereby said first and second frames are nested to form a sloped support descending towards the longitudinal center line of the bed system.

2. The bed system according to claim 1, wherein the extension rods comprise a scissor lifting device, which by actuation lifts the frame in the pivot point.

3. The bed system according to claim 1, wherein, wherein the first and/or second actuator is based on an electrical actuator attached to the one or more extension rods.

4. The bed system according to claim 1, wherein the control means is programmed to move the first and a second frame up and down, while ensuring a minimum angle therein between of at least 40 degrees.

5. An integrated hospital bed comprising:
a hospital bed; and
at least one bed system according to claim 1.

6. An integrated hospital bed comprising:
a hospital bed;
at least two bed systems according to claim 1;
wherein longitudinal extension bars are provided to longitudinally extend the frame parts along the length of the bed.
